(19) United States
(12) Patent Application Publication
(10) Pub. No.: US 2013/0185491 A1
(43) Pub. Date: Jul. 18, 2013

(54) MEMORY CONTROLLER AND A METHOD THEREOF

(71) Applicants: Ting-Wei Lin, Hsinchu City (TW); Che-Wei Chang, Hsinchu City (TW)

(72) Inventors: Ting-Wei Lin, Hsinchu City (TW); Che-Wei Chang, Hsinchu City (TW)

(73) Assignee: SKYMEDI CORPORATION, Hsinchu City (TW)

(21) Appl. No.: 13/351,668

(22) Filed: Jan. 17, 2012

(51) Int. Cl. G06F 12/00

(52) U.S. Cl. 711/104; 711/149; 711/E12.001

(57) ABSTRACT

A memory controller includes a mixed buffer and an arbiter. The mixed buffer includes at least one single-port buffer and at least one multi-port buffer for managing data flow between a host and a storage device. The arbiter determines an order of access to the mixed buffer among a plurality of masters. The data to be written or read are partitioned into at least two parts, which are then moved to the single-port buffer and the multi-port buffer, respectively.

### BACKGROUND OF THE INVENTION

1. Field of the Invention

The present invention generally relates to a memory controller, and more particularly to a mixed buffer adaptable to a memory controller.

2. Description of Related Art

An interface protocol is set up for better and faster communication between electronic devices. Common interface protocols are CompactFlash (CF), Memory Stick PRO (MS PRO), Secure Digital (SD), microSD (μ SD) and Universal Serial Bus (USB). A storage or memory device is a device for storing data. Common storage devices are hard disk, NOR flash, NAND flash and dynamic random access memory (DRAM). Both the interface protocol and the storage device call for high transfer rate to suit ever increasing demand for greater amount of data to be transferred or processed. However, the transfer rate of the interface protocol cannot generally match the transfer rate of the storage device, or vice versa. In order to alleviate the constraint owing to the mismatched transfer rate, a buffer is usually disposed between the interface and the storage device to adjust timing between different rates.

Conventional buffers, nevertheless, either inefficiently incur latency or disadvantageously require substantive circuit area. Therefore, a need has arisen to propose a memory controller with a novel buffer architecture that makes most utilizations from the buffers.

### SUMMARY OF THE INVENTION

In view of the foregoing, the embodiment of the present invention provides a memory controller and a memory controlling method with a mixed buffer that can take advantage of both a single-port memory and a dual-port memory, thereby fast and economically optimizing an entire performance of the memory controller.

According to one embodiment, the memory controller includes a mixed buffer and an arbiter. The mixed buffer is configured to manage data flow between a host and a storage device, the mixed buffer comprising at least one single-port buffer and at least one multi-port buffer. The arbiter is configured to determine an order of access to the mixed buffer among a plurality of masters. The data to be written or read are partitioned into at least two parts, which are then moved to the single-port buffer and the multi-port buffer, respectively.

### BRIEF DESCRIPTION OF THE DRAWINGS

FIG. 1 shows a block diagram of a memory controller according to one embodiment of the present invention;

FIG. 2A shows a detailed block diagram of the memory controller, in a master-slave perspective, according to the embodiment of the present invention;

FIG. 2B shows an exemplary memory controller of FIG. 2A;

FIG. 3 shows a detailed block diagram of the mixed buffer according to the embodiment of the present invention;

FIG. 4A illustrates a wrapping scheme adoptable by the single-port buffer and the dual-port buffer of FIG. 3;

FIG. 4B illustrates an internal move scheme adoptable by the single-port buffer and the dual-port buffer of FIG. 3;

FIG. 5A shows a simplified block diagram of a conventional memory controller that uses one single-port buffer and two backend devices;

FIG. 5B shows a simplified block diagram of the memory controller with two backend devices according to the embodiment of the present invention;

FIG. 6 shows a flow diagram illustrative of a memory controlling method according to one embodiment of the present invention;

FIG. 7A shows a detailed flow diagram illustrative of a write procedure of FIG. 6;

FIGS. 7B-7C illustrate data flow in the write procedure of FIG. 7A according to one embodiment of the present invention;

FIG. 8A shows a detailed flow diagram illustrative of a read procedure of FIG. 6;

FIGS. 8B-8C illustrate data flow in the read procedure of FIG. 8A according to one embodiment of the present invention;

FIGS. 9A-9B illustrate data flow in a write procedure for a two-plane storage device according to another embodiment of the present invention; and

FIGS. 10A-10B illustrate data flow in a read procedure for a two-plane storage device according to another embodiment of the present invention.

### DETAILED DESCRIPTION OF THE INVENTION

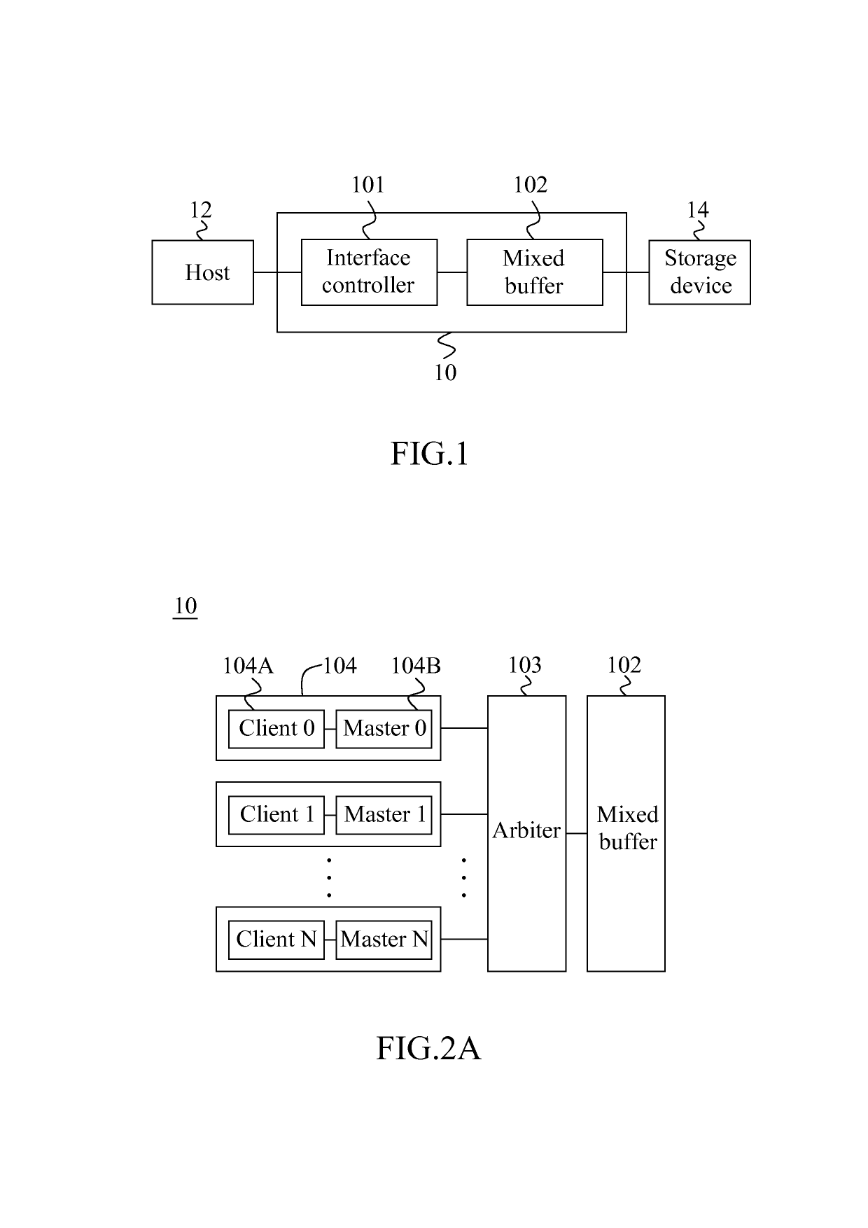

FIG. 1 shows a block diagram of a memory controller 10 according to one embodiment of the present invention. The memory controller 10 includes an interface controller 101 that handles communication protocol, such as CompactFlash (CF), Memory Stick PRO (MS PRO), Secure Digital (SD), microSD (μ SD), embedded Multi Media Card (eMMC) or Universal Serial Bus (USB), with a host (e.g., a computer) 12. The memory controller 10 also includes a mixed buffer 102 that manages data flow between the host 12 and a storage device 14, such as hard disk, NOR flash, NAND flash or dynamic random access memory (DRAM). The mixed buffer 102 may include, but not be limited to, random access memory (RAM). The memory controller 10 may, but not necessarily, be integrated with the storage device 14.

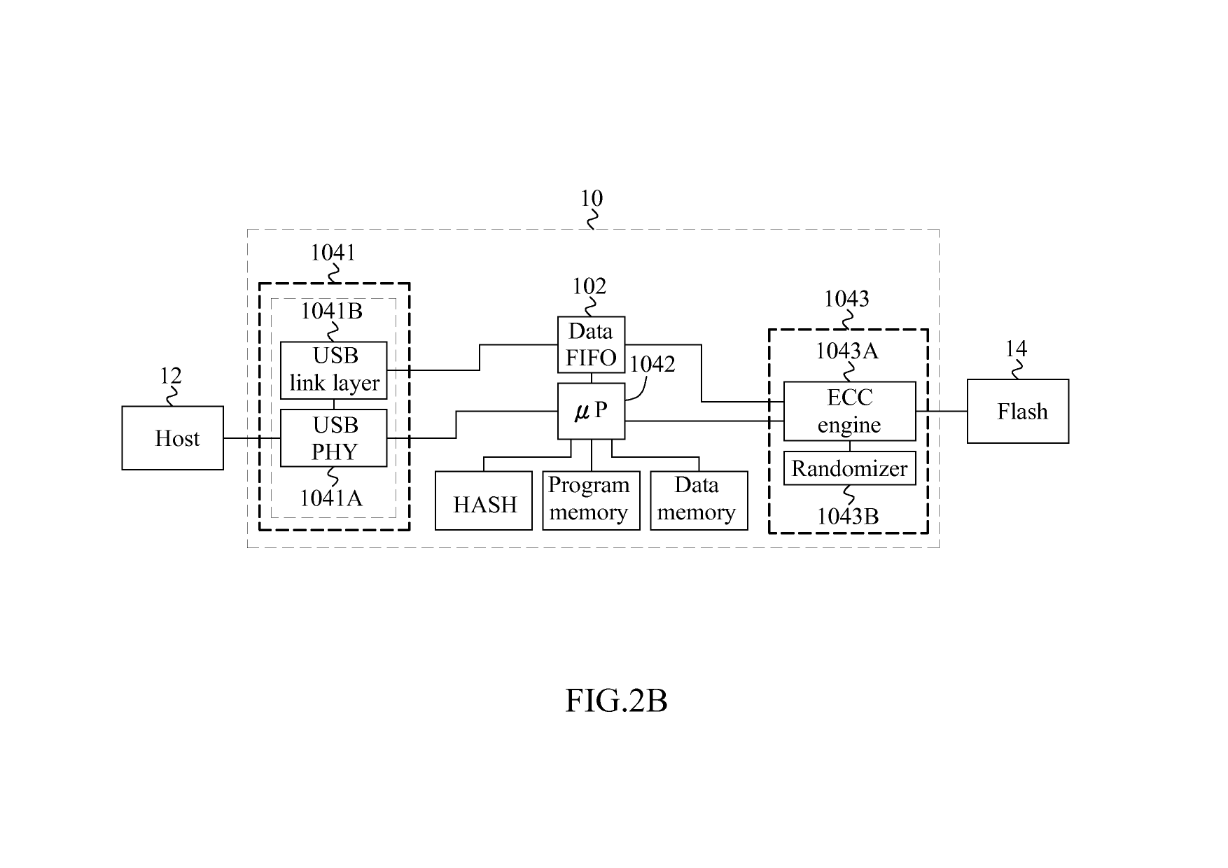

FIG. 2A shows a detailed block diagram of the memory controller 10, in a master-slave perspective, according to the embodiment of the present invention. In the embodiment, an arbiter 103 determines the order of access to the mixed buffer 102 (as the slave) among modules 104, each of which includes a client 104A that requests its associated master 104B. The arbiter 103 of the embodiment may adopt a round-robin scheduling, by which time slices are assigned, without priority, to each module 104 in circular order.

FIG. 2B shows an exemplary memory controller 10 disposed between a host 12 and a flash 14. The memory controller 10 includes the following modules acting as the masters: a USB interface 1041 having a USB physical layer (PHY) 1041A and a USB link layer 1041B, a microprocessor (μ P) 1042, and an error-correcting controller (ECC) 1043 having an ECC engine 1043A and a randomizer 1043B. These modules 1041, 1042 and 1043, in general, belong to different clock domains, respectively. The memory controller 10 also includes a data FIFO (first-in first-out) 102 acting as the slave.

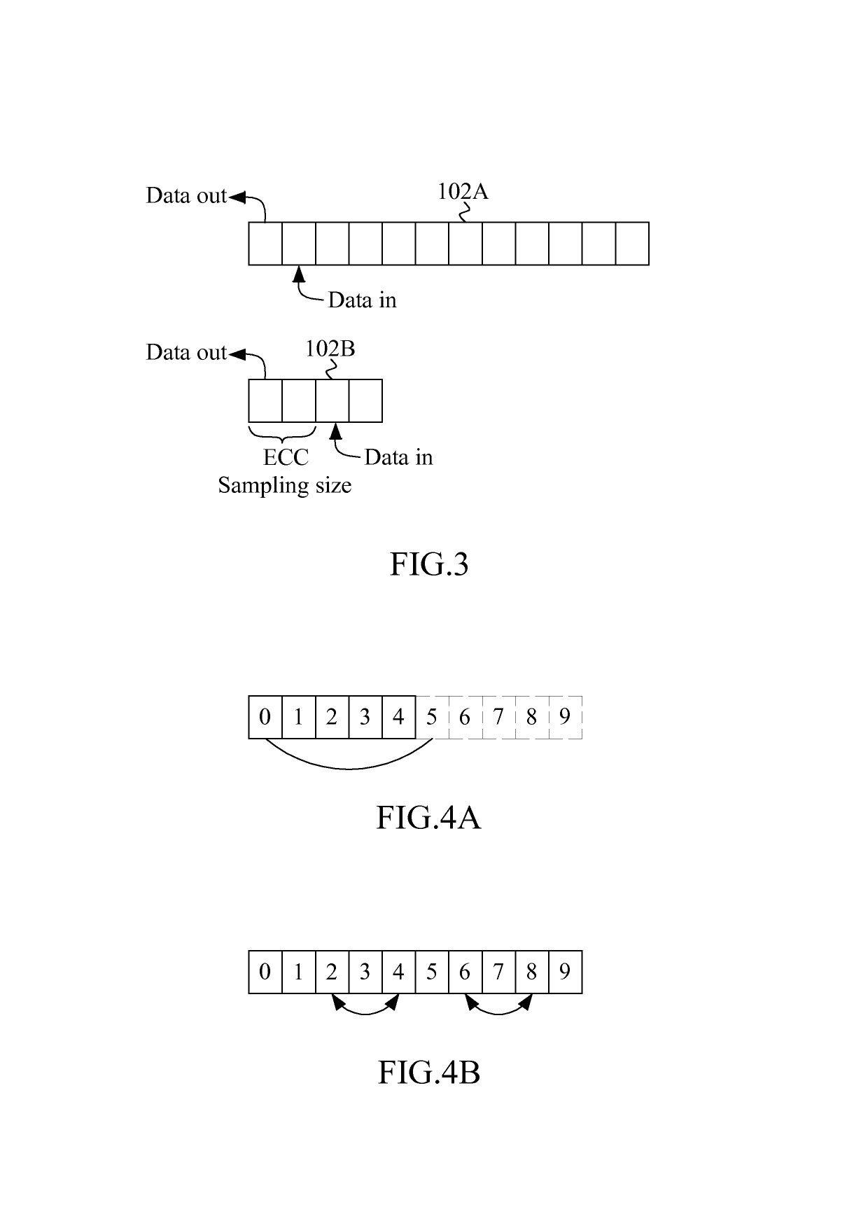

FIG. 3 shows a detailed block diagram of the mixed buffer 102 according to the embodiment of the present invention. In the embodiment, the mixed buffer 102 includes a single-port buffer 102A and a dual-port buffer (or a multi-port buffer, in general) 102B. Each block in the diagram denotes a (physical) data transmission unit, e.g., having a size of 512 bytes. The single-port buffer 102A is a memory device (e.g., RAM) that allows only one read/write access at a time. Accordingly, the single-port buffer 102A is liable to latency when read and write operations are alternatingly performed. The dual-port buffer 102B is a memory device that allows multiple read or write operations at a time without latency. It is noted that the dual-port buffer 102B performs faster than the single-port buffer 102A, however, at the cost of higher circuit area (or gate count). It is thus the motivation behind the embodiment that uses both the single-port buffer 102A and the dual-port buffer (or multi-port buffer, in general) 102B, which are tailored to optimize their respective utilizations. As a result, the written/read data are therefore partitioned into two parts, which are then moved to the single-port buffer 102A and the dual-port buffer 102B, respectively. In the embodiment, as shown in FIG. 3, the single-port buffer 102A has a size of two pages, and the dual-port buffer 102B has a size of two times a maximal data amount that is capable of being processed by an ECC engine e.g., 1043A in FIG. 2B). Generally speaking, the size of the dual-port buffer 102B is smaller than the size of the single-port buffer 102A, due to the multiple read/write capability of the dual-port buffer 102B.

it is appreciated that either the single-port buffer 102A or the dual-port buffer 102B may adopt wrapping (or address overlap mapping) scheme as illustrated in FIG. 4A. In the figure, solid blocks denote physical memory blocks and dashed blocks denote virtual memory blocks. The virtual memory block numbered 5, for example, is mapped to the physical memory block numbered 0. Accordingly, the access to the memory block 5 is equivalent to the access to the memory 0. By utilizing the wrapping scheme, the size of either the single-port buffer 102A or the dual-port buffer 102B may be substantially reduced. It is also appreciated that either the single-port buffer 102A or the dual-port buffer 102B may adopt internal data move scheme as illustrated in FIG. 4B. For example, the contents of the memory blocks 2 and 4 may be interchanged internally.

FIG. 5A shows a simplified block diagram of a conventional memory controller that uses one single-port buffer 2 and two (or more) backend devices BE0 and BE1 that act as an interface with a storage device (not shown) to realize multi-channel implementation. The backend devices BE0 and BE1 may, for example, perform a copyback operation of the storage device, or perform an ECC operation. It is noted that the single-port buffer 2 in this architecture needs a size of two times the normal buffer size in order to accommodate the two backend devices BE0 and BE1 FIG. 5B shows a simplified block diagram of the memory controller 10 with two (or more) backend devices BE0 and BE1 according to the embodiment of the present invention. As the memory controller 10 of the embodiment uses both the single-port buffer 102A and the dual-port buffer 102B (as shown in FIG. 3), the single-port buffer 102A needs a size of only half of the single-port buffer 2 of FIG. 5A.

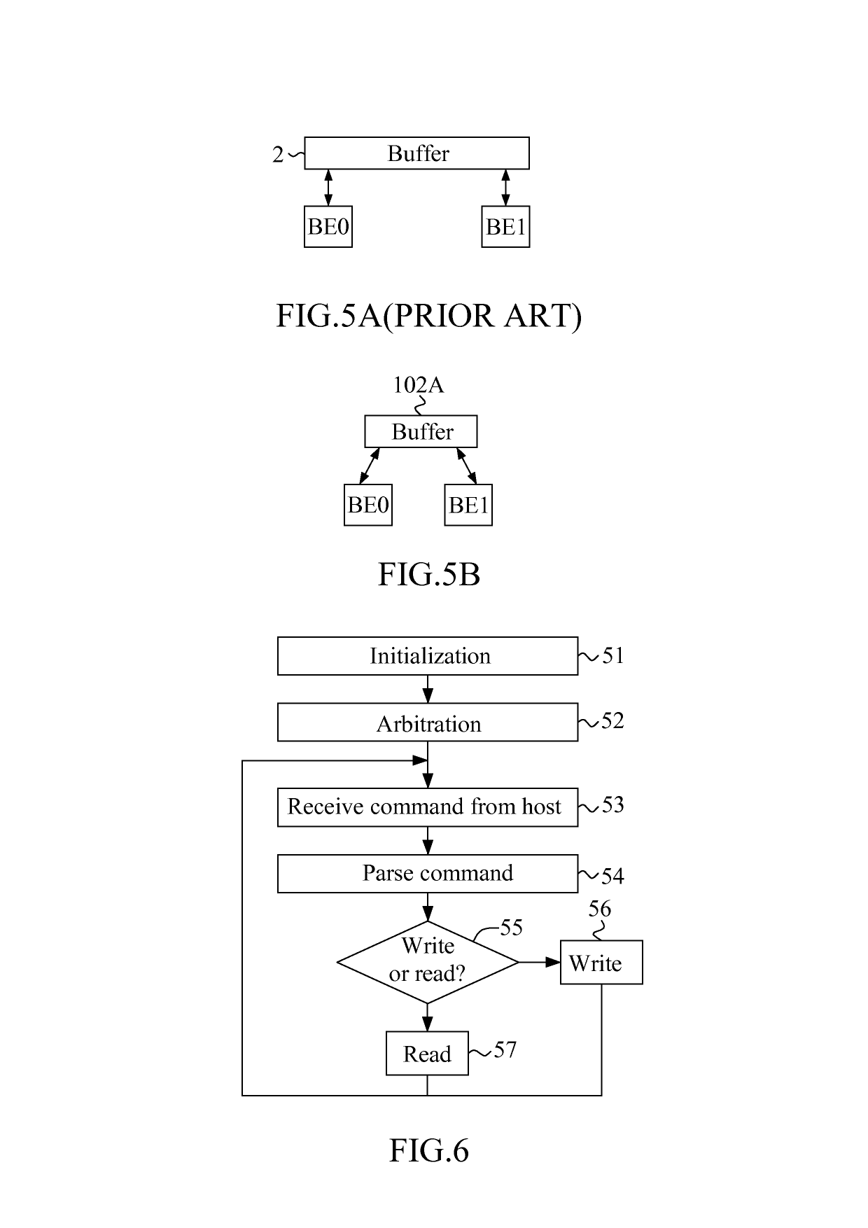

FIG. 6 shows a flow diagram illustrative of a memory controlling method according to one embodiment of the present invention. After system initialization (step 51), the arbiter 103 arbitrates to select one among the masters (step 52). In step 53, a command is received, from the host 12, followed by parsing the received command (step 54). According to the parsing result, step 55 decides whether a write procedure or a read procedure is requested. If a write procedure is requested, the flow proceeds to step 56, otherwise goes to step 57.

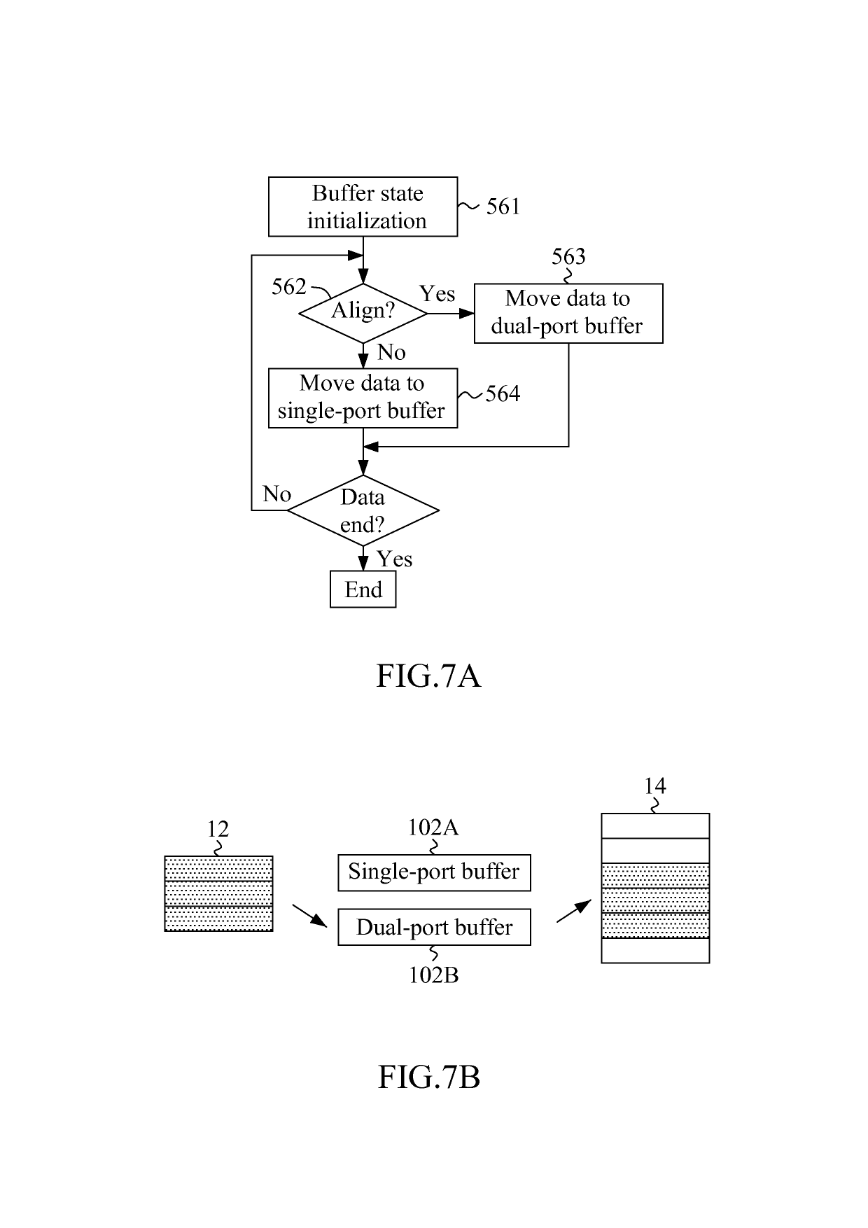

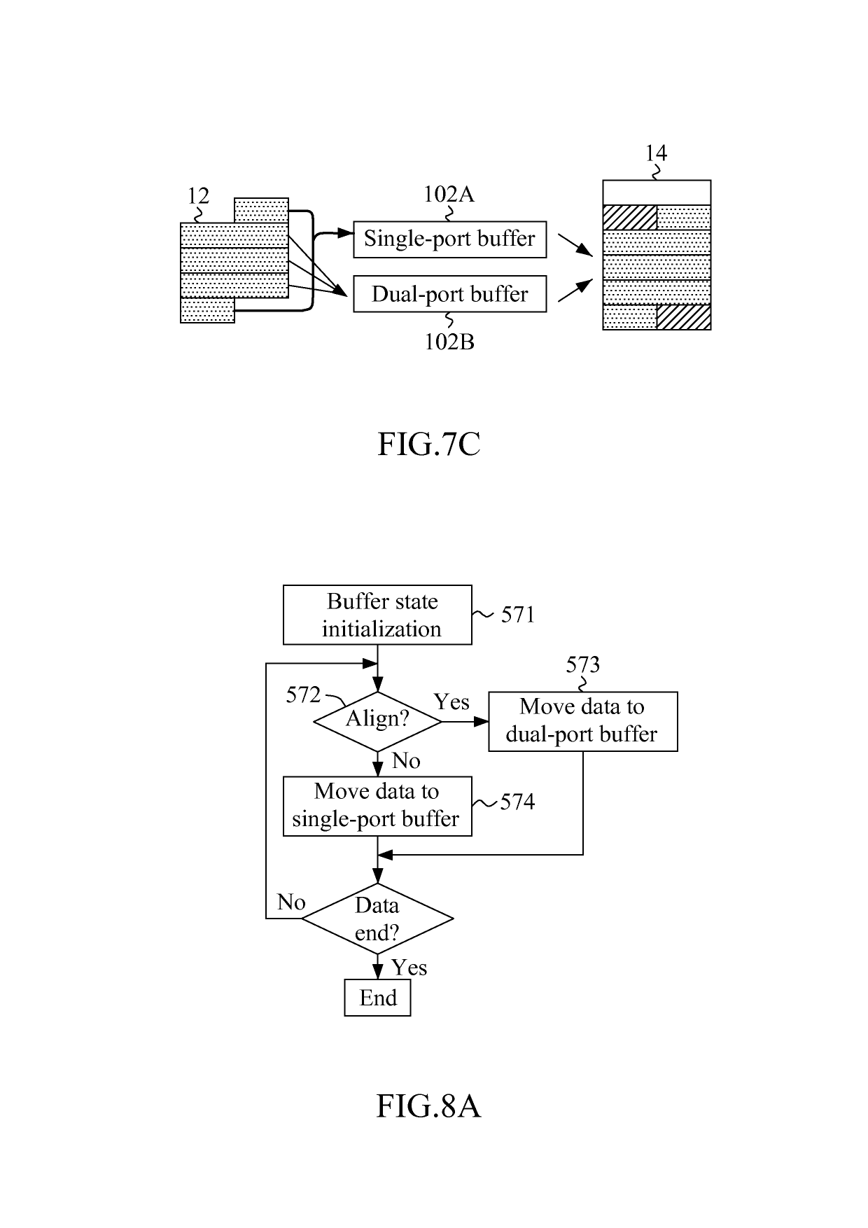

FIG. 7A shows a detailed flow diagram illustrative of a write procedure of FIG. 6, and FIGS. 7B-7C illustrate data flow in the write procedure according to one embodiment of the present invention. After buffer state initialization (step 561), step 562 is performed to determine whether data to be written from the host 12 to the storage device 14 are aligned with data unit boundary (e.g., backend device boundary) with a predetermined width. As shown in FIG. 7B, the written data are aligned with the data unit boundary (e.g., page boundary), and the written data are thus moved to the dual-port buffer 102B (step 563). If it is determined in step 562 that the written data are not aligned with the data unit boundary, as shown in FIG. 7C, the unaligned data (e.g., the first and the fifth items in FIG. 7C) are moved to the single-port buffer 102A (step 564), while the aligned data (e.g., the second through the fourth items in FIG. 7C) are moved to the dual-port buffer 102B (step 563). The procedure discussed above iterates until the end of the written data has been reached.

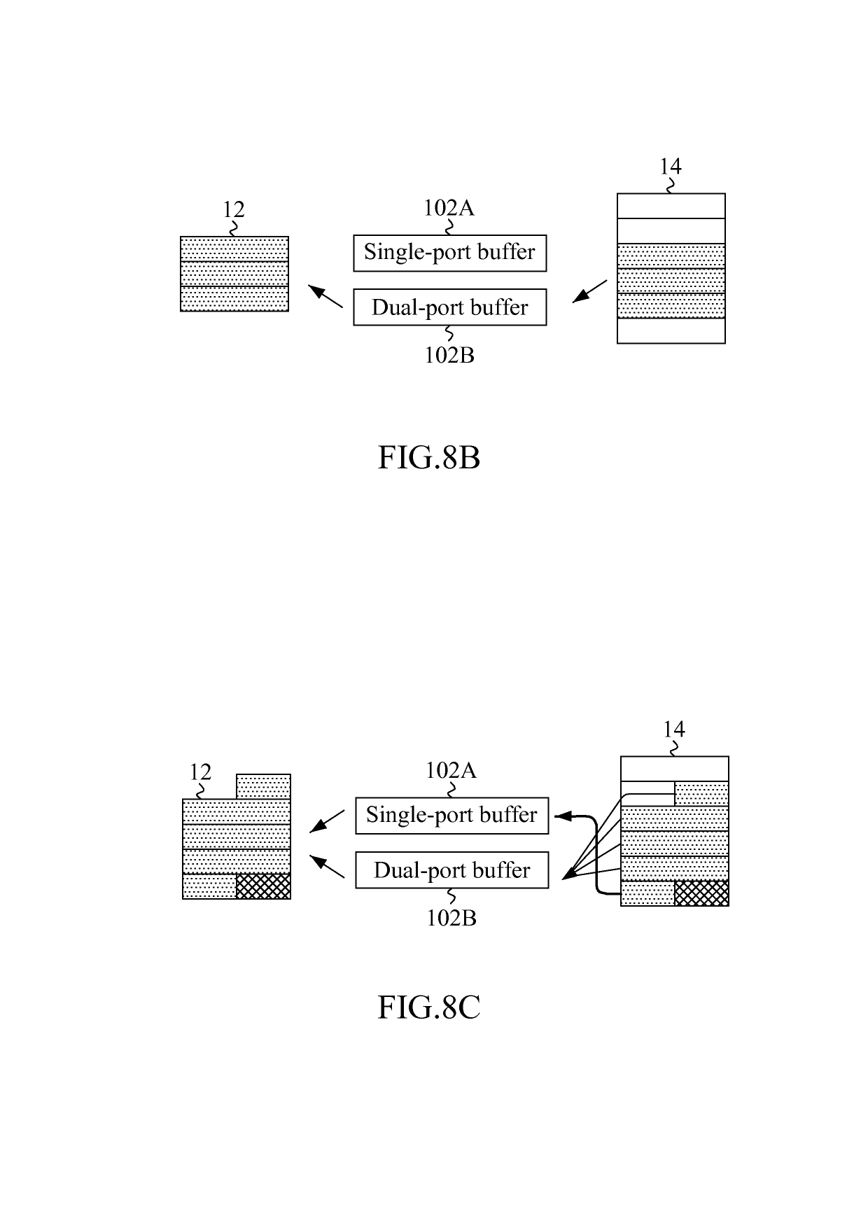

FIG. 8A shows a detailed flow diagram illustrative of a read procedure of FIG. 6, and FIGS. 8B-8C illustrate data flow in the read procedure according to one embodiment of the present invention. After buffer state initialization (step 571), step 572 is performed to determine whether data (particularly the last data unit) to be read from the storage device 14 to the host 12 are aligned with data unit boundary (e.g., backend device boundary). As shown in FIG. 8B, the read data are aligned with the data unit boundary (e.g., page boundary), and the read data are thus moved to the dual-port buffer 102B (step 573). If it is determined in step 572 that the read data of the last data unit are not aligned with the data unit boundary, as shown in FIG. 8C, the unaligned data e.g., the fifth items in FIG. 5C) are moved to the single-port buffer 102A (step 574). It is noted that, in the embodiment, the unaligned data of the first data unit may be moved to the dual-port buffer 102B. It is further noted that the ensuant data (denoted by hatched lines) in the last data unit with the unaligned data are also moved to the single-port buffer 102A, such that those ensuant data may be pre-fetched to the host 12. The procedure discussed above iterates until the end of the read data has been reached.

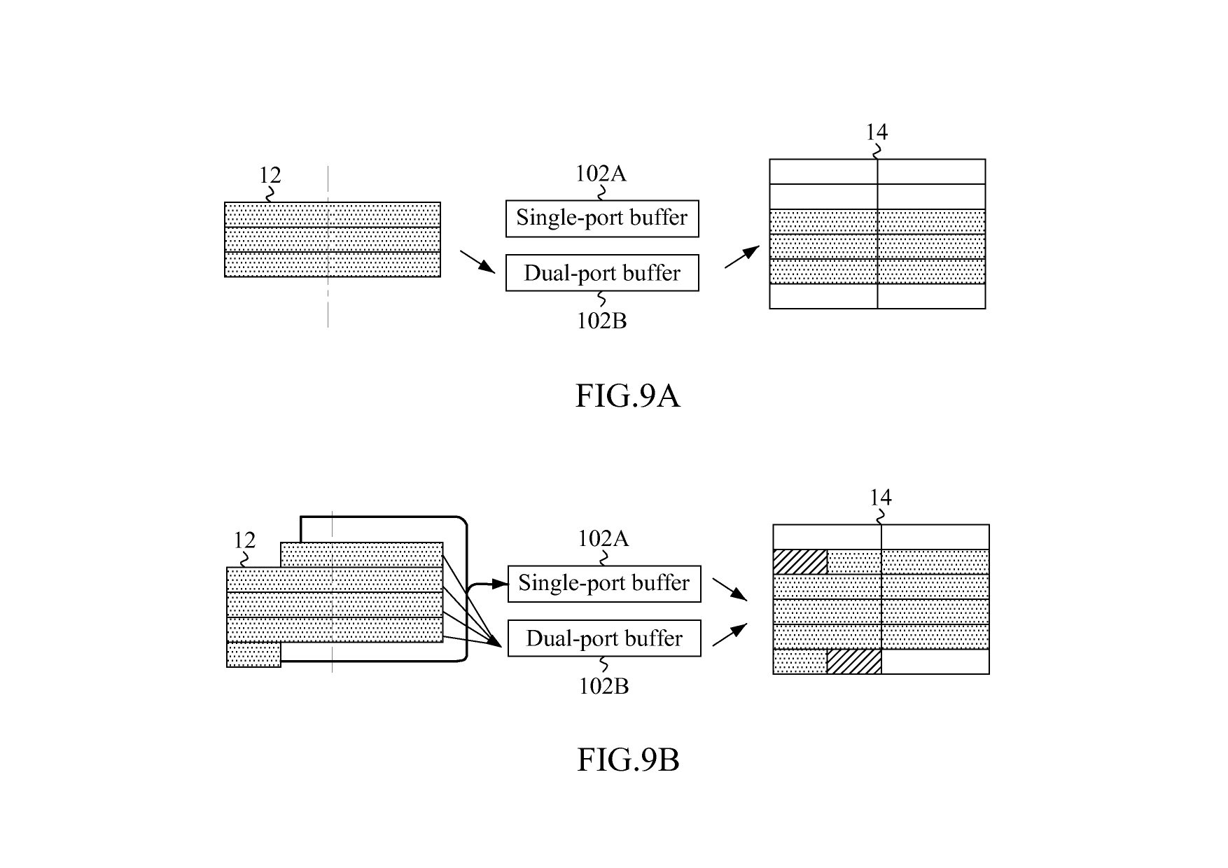

FIGS. 9A-9B illustrate data flow in a write procedure for a two-plane storage device (or a multi-plane storage device, in general) according to another embodiment of the present invention. In the embodiment, it is determined whether written data are aligned with the corresponding data plane boundary with a predetermined width. As shown in FIG. 9A, the written data are aligned with the data plane boundary, and the written data are thus moved to the dual-port buffer 102B. If it is determined that the written data are not aligned with the corresponding data plane boundary, as shown in FIG. 9B, the unaligned data (e.g., the left half of the first item and the left half of the fifth items in FIG. 9B) are moved to the single-port buffer 102A, while the other aligned data are moved to the dual-port buffer 102B.

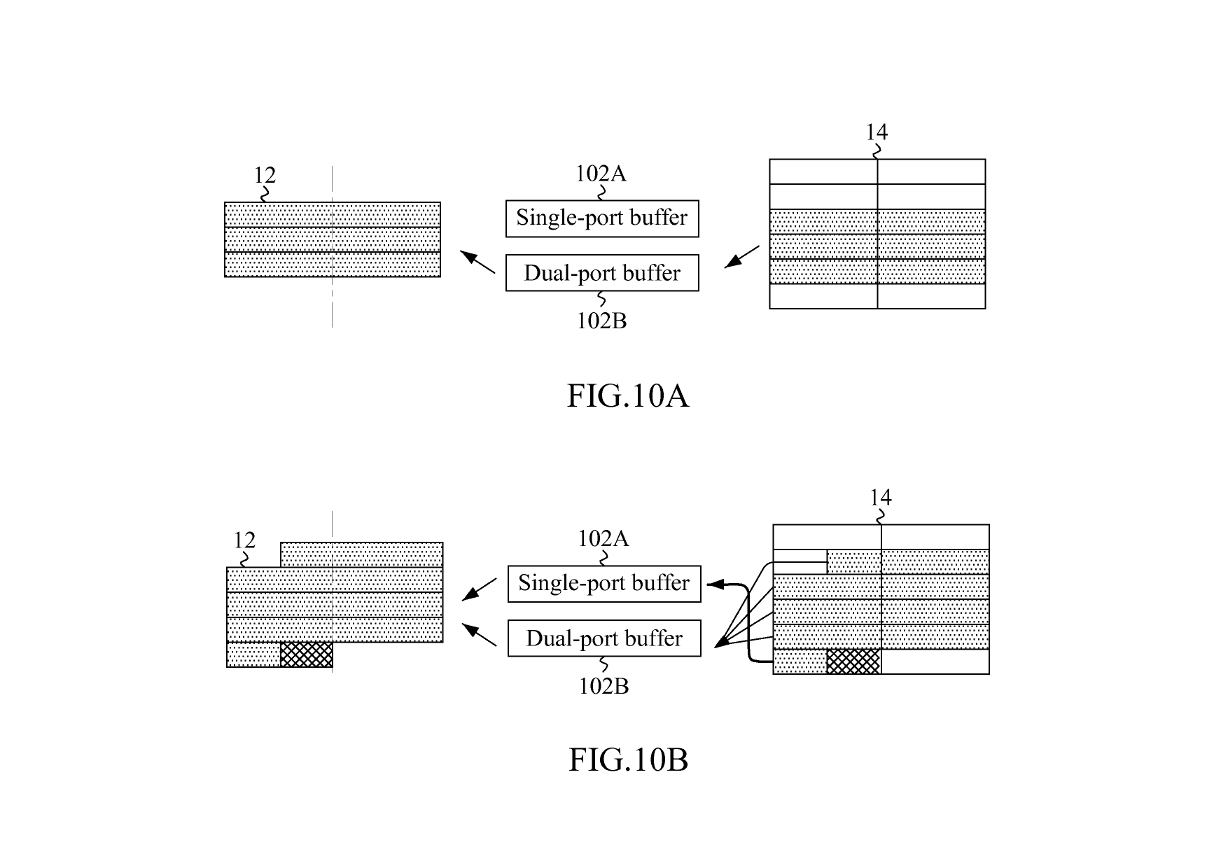

FIGS. 10A-10B illustrate data flow in a read procedure for a two-plane storage device (or a multi-plane storage device, in general) according to another embodiment of the present invention. In this embodiment, it is determined whether data (particularly the last data unit) to be read from the storage device 14 to the host 12 are aligned with data plane boundary. As shown in FIG. 10A, the read data are aligned with the data plane boundary, and the read data are thus moved to the dual-port buffer 102B. If it is determined that the read data of the last data plane are not aligned with the data plane boundary, as shown in FIG. 10B, the unaligned data (e.g., the last (left) data plane in FIG. 10B) are moved to the single-port buffer 102A. It is noted that the ensuant data (denoted by hatched lines) in the unaligned data of the last data plane are also moved to the single-port buffer 102A, such that those ensuant data may be pre-fetched to the host 12.

Although specific embodiments have been illustrated and described, it will be appreciated by those skilled in the art that various modifications may be made without departing from the scope of the present invention, which is intended to be limited solely by the appended claims.

What is claimed is:

1. A memory controller, comprising:
a mixed buffer configured to manage data flow between a host and a storage device, the mixed buffer comprising at least one single-port buffer and at least one multi-port buffer; and
an arbiter configured to determine an order of access to the mixed buffer among a plurality of masters;
wherein data to be written or read are partitioned into at least two parts, which are then moved to the single-port buffer and the multi-port buffer, respectively.

2. The memory controller of claim 1, wherein the mixed buffer comprises a random access memory (RAM).

3. The memory controller of claim 1, wherein the master comprises a USB interface, a microprocessor or an error-correcting controller (ECC).

4. The memory controller of claim 1, wherein the single-port buffer or the multi-port buffer adopts a wrapping scheme.

5. The memory controller of claim 1, if data to be written to the storage device are aligned with a data unit boundary with a predetermined width, the aligned data are moved to the multi-port buffer; and if the written data are not aligned, with the data unit boundary, the unaligned data are moved to the single-port buffer.

6. The memory controller of claim 1, if data to be read to the host are aligned with a data unit boundary with a predetermined width, the aligned data are moved to the multi-port buffer; and if the read data of a last data unit are not aligned with the data unit boundary, the unaligned data are moved to the single-port buffer.

7. The memory controller of claim 6, wherein ensuant data in the last data unit with unaligned data are also moved with the unaligned data to the single-port buffer, such that the ensuant data are pre-fetched to the host.

8. The memory controller of claim 1, wherein the storage device comprises a plurality of data planes, if data to be written to the storage device are aligned with a data plane boundary with a predetermined width, the aligned data are moved to the multi-port buffer; and if the written data are not aligned with the data plane boundary, the unaligned data are moved to the single-port buffer.

9. The memory controller of claim 1, wherein the storage device comprises a plurality of data planes, if data to be read to the host are aligned with a data plane boundary with a predetermined width, the aligned data are moved to the multi-port buffer; and if the read data of a last data unit are not aligned with the data plane boundary, the unaligned data are moved to the single-port buffer.

10. The memory controller of claim 9, wherein ensuant data in the last data unit with unaligned data are also moved with the unaligned data to the single-port buffer, such that the ensuant data are pre-fetched to the host.

11. A memory controlling method, comprising;
providing a mixed buffer for managing data flow between a host and a storage device, the mixed buffer comprising at least one single-port buffer and at least one multi-port buffer;
arbitrating among a plurality of masters to determine an order of access to the mixed buffer;
parsing a command received from the host to decide whether a write procedure or a read procedure is requested; and
partitioning data to be written or read into at least two parts, which are then moved to the single-port buffer and the multi-port buffer, respectively.

12. The method of claim 11, wherein the mixed buffer comprises a random access memory (RAM).

13. The method of claim 11, wherein the single-port buffer or the multi-port buffer adopts a wrapping scheme.

14. The method of claim 11, further comprising a step of determining whether data to be written to the storage device are aligned with a data unit boundary with a predetermined width, if the written data are aligned with the data unit boundary, the aligned data are moved to the multi-port buffer; and if the written data are not aligned with the data unit boundary, the unaligned data are moved to the single-port buffer.

15. The method of claim 11, further comprising a step of determining whether data to be read to the host are aligned with a data unit boundary with a predetermined width, if the read data are aligned with the data unit boundary, the aligned data are moved to the multi-port buffer; and if the read data of a last data unit are not aligned with the data unit boundary, the unaligned data are moved to the single-port buffer.

16. The method of claim 15, wherein ensuant data in the last data unit with unaligned data are also moved with the unaligned data to the single-port buffer, such that the ensuant data are pre-fetched to the host.

17. The method of claim 11, further comprising a step of determining whether data to be written to the storage device are aligned with a data plane boundary with a predetermined width, wherein the storage device comprises a plurality of data planes, if the written data are aligned with the data plane boundary, the aligned data are moved to the multi-port buffer; and if the written data are not aligned with the data plane boundary, the unaligned data are moved to the single-port buffer.

18. The method of claim 11, further comprising a step of determining whether data to be read to the host are aligned with a data plane boundary with a predetermined width, wherein the storage device comprises a plurality of data planes, if the read data are aligned with the data plane boundary, the aligned data are moved to the multi-port buffer; and if the read data of a last data unit are not aligned with the data plane boundary, the unaligned data are moved to the single-port buffer.

19. The method of claim 18, wherein ensuant data in the last data unit with unaligned data are also moved with the unaligned data to the single-port buffer, such that the ensuant data are pre-fetched to the host.
